(19) United States
(12) Patent Application Publication
(10) Pub. No.: US 2007/0204238 A1
(43) Pub. Date: Aug. 30, 2007

(54) Smart Video Presentation

(75) Inventors: Xian-Sheng Hua, Beijing (CN); Lai Wei, Redmond, WA (US); Shipeng Li, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/688,165

(22) Filed: Mar. 19, 2007

Related U.S. Application Data
(63) Continuation-in-part of application No. 11/276,364, filed on Feb. 27, 2006.

(51) Int. Cl. H04N 5/222

(52) U.S. Cl. 715/838; 348/333.05

(57) ABSTRACT

Smart video presentation involves presenting one or more videos in a video presentation user interface (IU). In example implementation, a video presentation UI includes a listing of multiple video entries, with each video entry including multiple static thumbnailes to represent the corresponding video. In another example implementation, a video presentation UI includes a scalable number of static thumbnails to represent a video, with the scalable number adjustable by a user with a scaling interface tool. In yet another example implementation, a video presentation UI includes a video playing region, a video slider bar region, and a filmstrip region that presents multiple static thumbnails for a video that is playable in the video playing region.

### CROSS-REFERENCE(S) TO RELATED APPLICATION(S)

This Nonprovisional U.S. Patent Application is a continuation-in-part application of copending U.S. Nonprovisional patent application Ser. No. 11/276,364 to Xian-Sheng Hua et al. filed on 27 Feb. 2006 and entitled “Video Search and Services”. Copending U.S. Nonprovisional patent application Ser. No. 11/276,364 is hereby incorporated by reference in its entirety herein.

### BACKGROUND

People and organizations store a significant number of items on their computing devices. These items can be text files, data files, images, videos, or some combination thereof. To be able to utilize such items, users must be able to locate, retrieve, manipulate, and otherwise manage those items that interest them. Among the various types of items, it can be particularly challenging to locate and/or manage videos due to their dynamic nature and oftentimes long lengths.

### SUMMARY

Smart video presentation involves presenting one or more videos in a video presentation user interface (UI). In an example implementation, a video presentation UI includes a listing of multiple video entries, with each video entry including multiple static thumbnails to represent the corresponding video. In another example implementation, a video presentation UI includes a scalable number of static thumbnails to represent a video, with the scalable number adjustable by a user with a scaling interface tool. In yet another example implementation, a video presentation UI includes a video playing region, a video slider bar region, and a filmstrip region that presents multiple static thumbnails for a video that is playable in the video playing region.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, apparatus, device, media, procedure, application programming interface (API), arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram illustrating an example environment in which smart video presentations may be implemented.

FIG. 2 is a block diagram illustrating an example grid view for smart video presentation.

FIG. 3 is a block diagram illustrating example functionality buttons for smart video presentation.

FIG. 4 is a block diagram illustrating an example list view for smart video presentation.

FIG. 5A is a block diagram illustrating a first example scalable view for smart video presentation.

FIG. 5B is a block diagram illustrating a second example scalable view for smart video presentation.

FIG. 6 is a block diagram illustrating an example filmstrip view for smart video presentation.

FIG. 7 is a flow diagram that illustrates an example of a method for handling user interaction with a filmstrip view implementation of a smart video presentation.

FIG. 8 is a block diagram illustrating an example tagging view for smart video presentation.

FIGS. 9A-9D are abbreviated diagrams illustrating example user interface aspects of video grouping by category for smart video presentation.

FIG. 10 is a block diagram of an example device that may be used to implement smart video presentations.

### DETAILED DESCRIPTION

### Introduction to Smart Video Presentation

It can be particularly challenging to locate and/or manage videos due to their dynamic nature and oftentimes long lengths. Video is a temporal sequence; consequently, it is difficult to quickly grasp the main idea of a video, especially as compared to an image or a text article. Although fast forward and fast backward functions can be used, a person still generally needs to watch an entire video, or at least a substantial portion of it, to determine whether it is a desired video and/or includes the desired moving image content.

In contrast, certain implementations as described herein can facilitate rapidly ascertaining whether a particular video is a desired video or at least includes desired moving image content. Moreover, a set of content-analysis-based video presentation user interfaces (UIs) named smart video presentation is described. Certain implementations of these video presentations UIs can help users rapidly grasp the main content of one video and/or multiple videos.

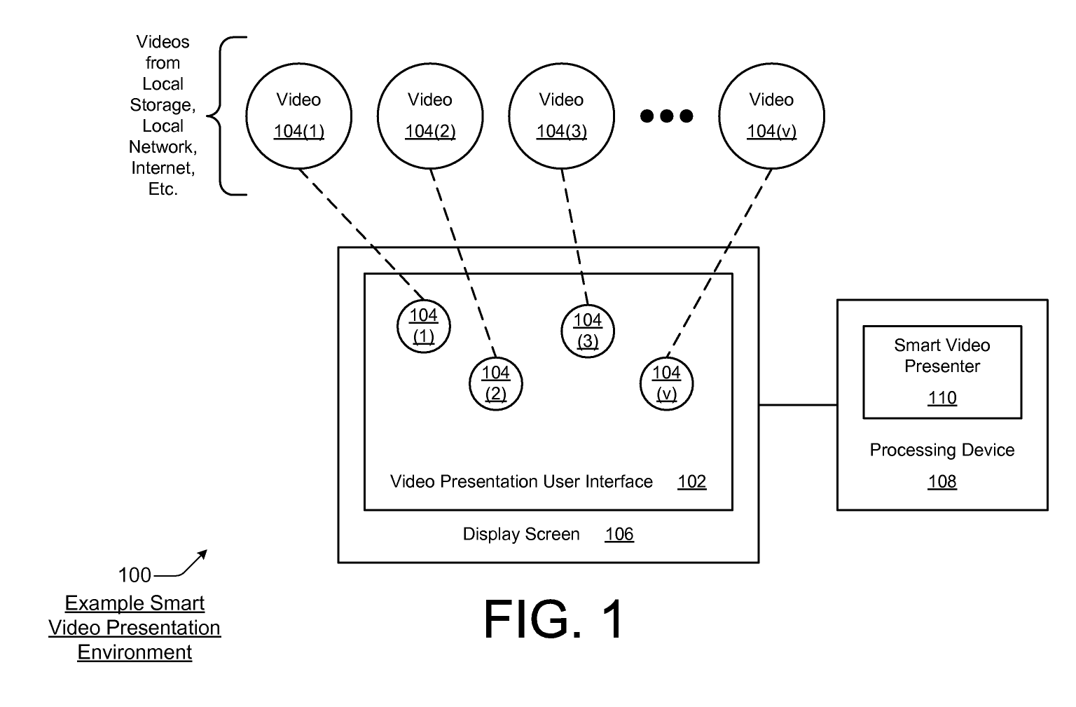

FIG. 1 is a block diagram illustrating an example environment 100 in which smart video presentations may be implemented. Example environment 100 includes a video presentation UI 102, multiple videos 104, a display screen 106, a processing device 108, and a smart video presenter 110. As illustrated, there are “v” videos 104(1), 104(2), 104(3) . . . 104(v), with “v” representing some integer. Videos 104(1-v) are ultimately presented on video presentation UI 102 in accordance with one or more views, which are described herein below.

Videos 104 can be stored at local storage, on a local network, over the internet, some combination thereof, and so forth. For example, they may be stored on flash memory or a local hard drive. They may also be stored on a local area network (LAN) server. Alternatively, they may be stored at a server farm and/or storage area network (SAN) that is connected to the internet. In short, videos 104 may be stored at and/or retrieved from any processor-accessible media.

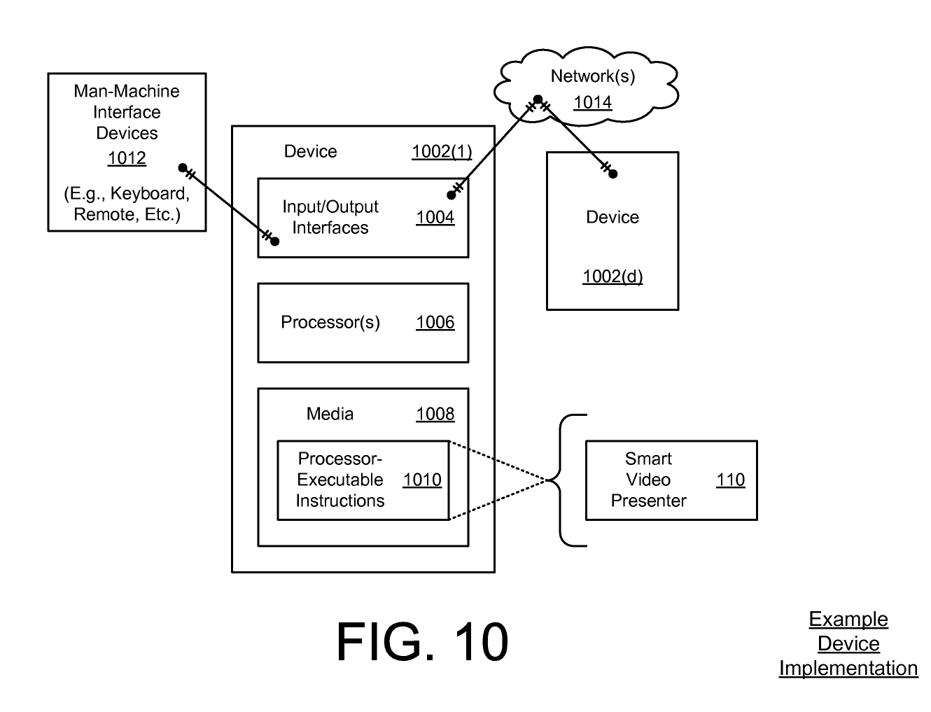

Processing device 108 may be any processor-driven device. Examples include, but are not limited to, a desktop computer, a laptop computer, a mobile phone, a personal digital assistant, a television-based device, a workstation, a network-based device, some combination thereof, and so forth. Display screen 106 may be any display screen technology that is coupled to and/or integrated with processing device 108. Example technologies include, but are not limited to, cathode ray tube (CRT), light emitting diode (LED), organic LED (OLED), liquid crystal display (LCD), plasma, surface-conduction electron-emitter display (SED), some combination thereof, and so forth. An example device that is capable of implementing smart video presentations is described further herein below with particular reference to FIG. 10.

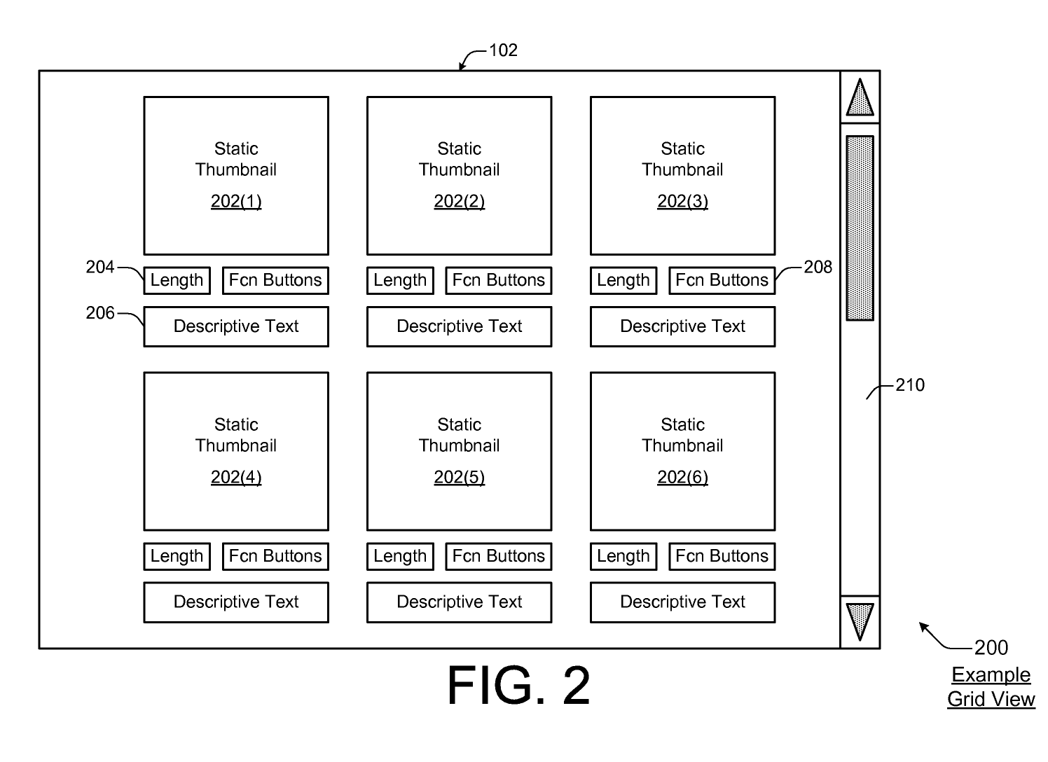

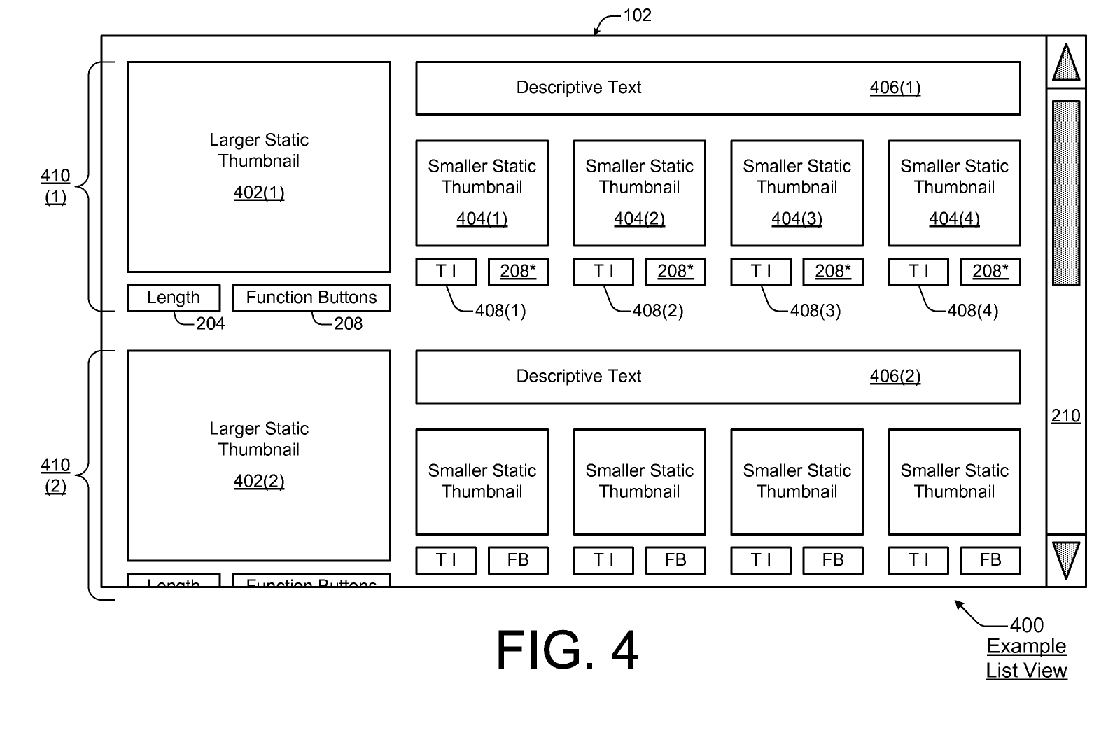

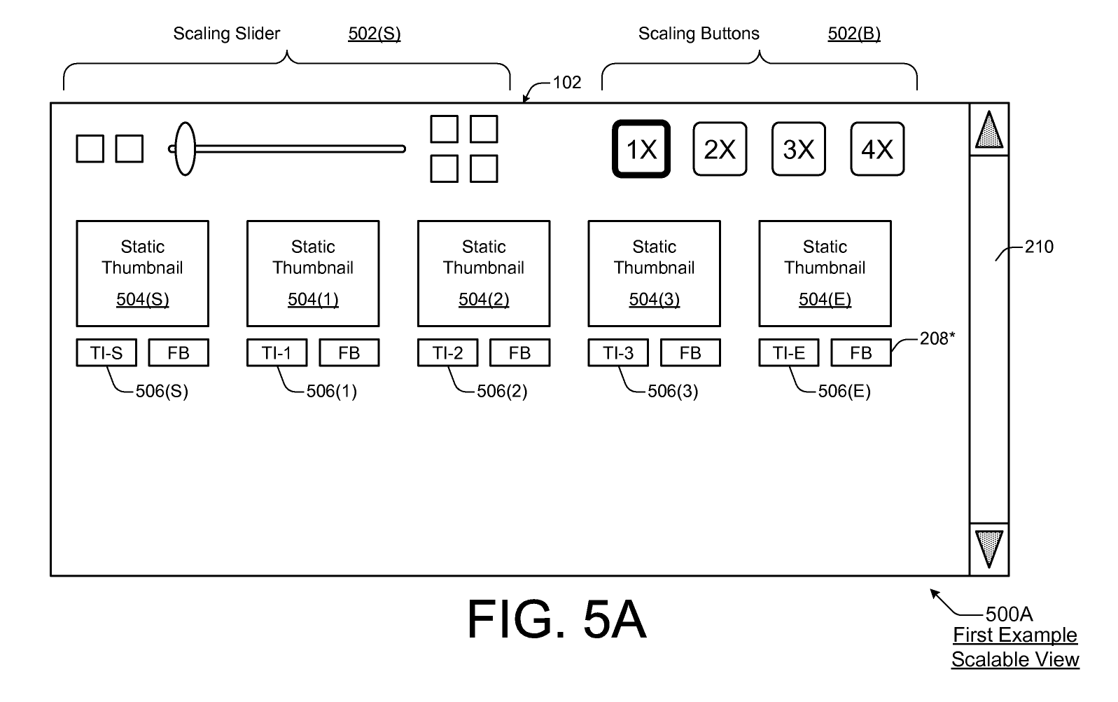

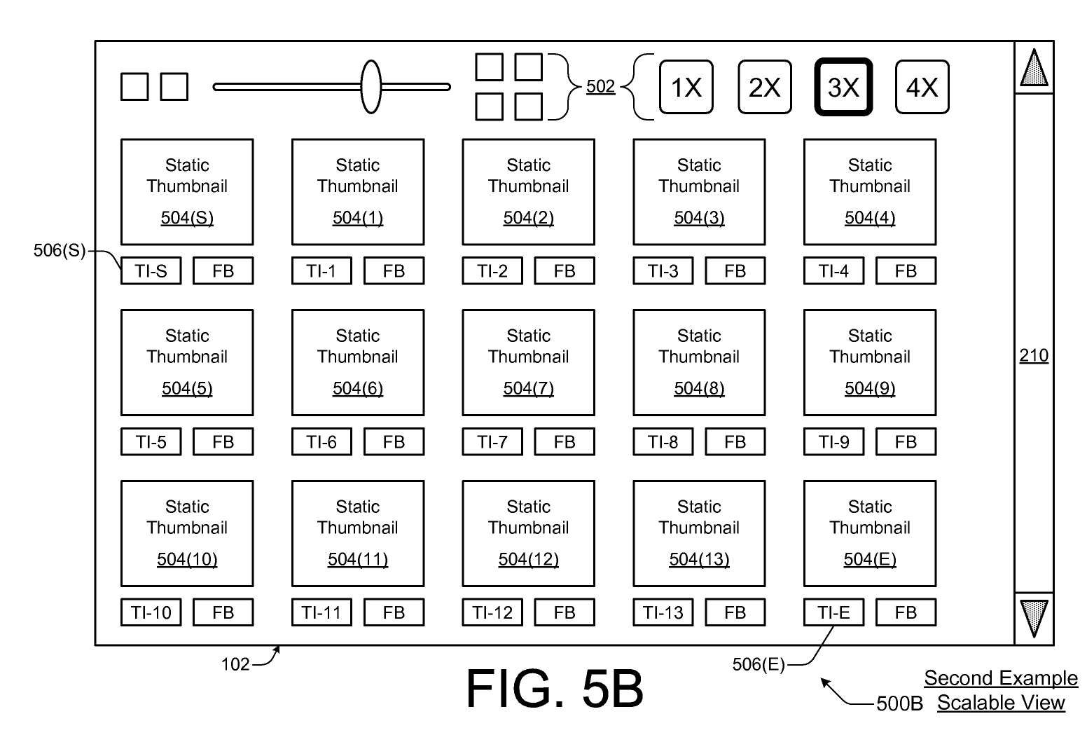

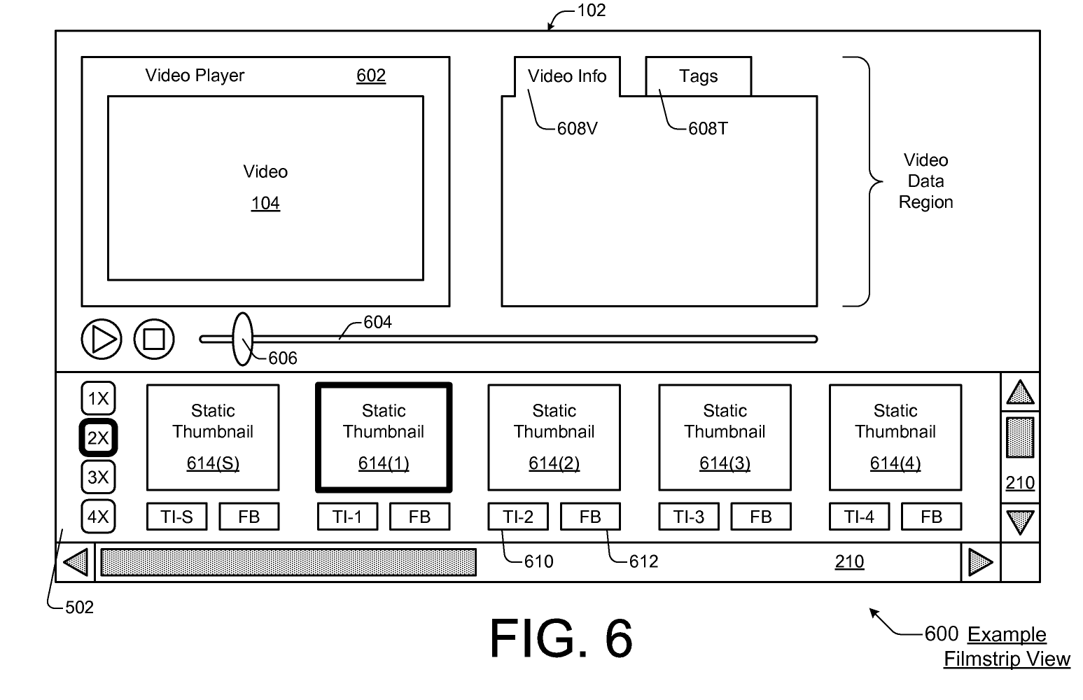

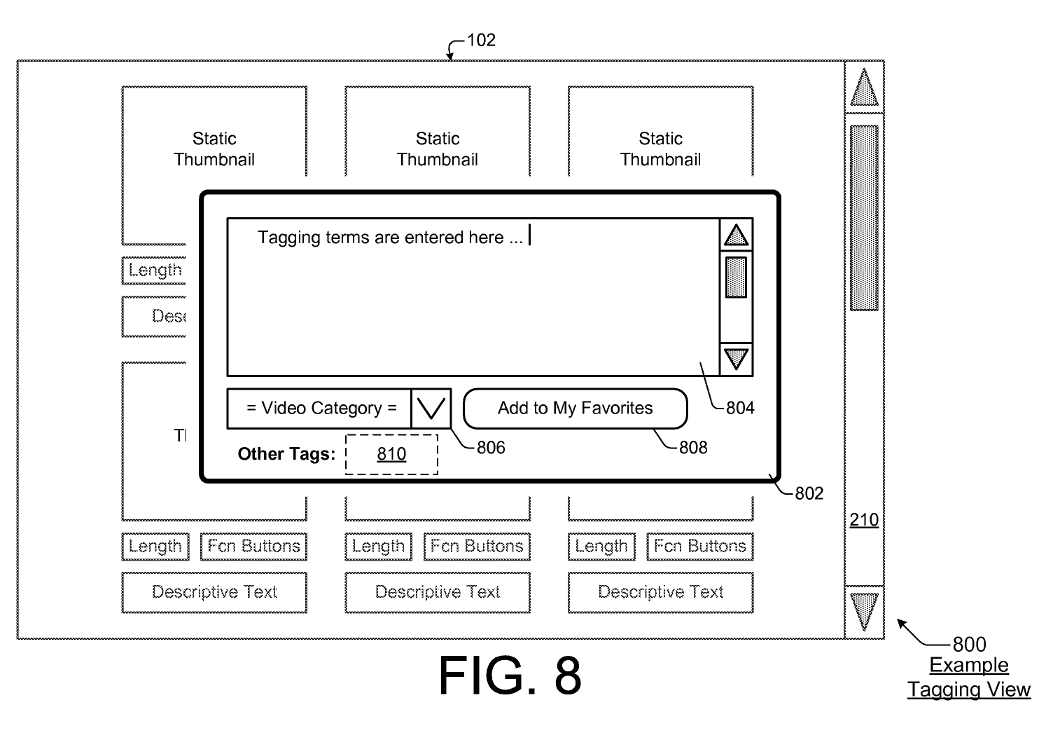

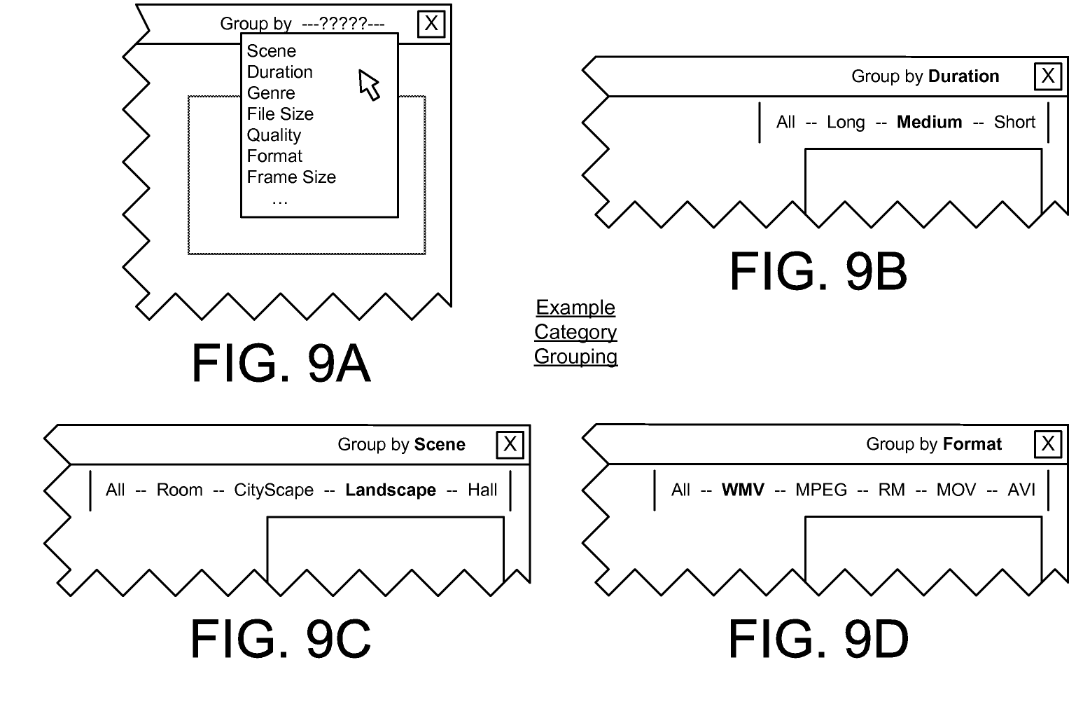

Smart video presenter 110 executes on processing device 108. Smart video presenter 110 may be realized as hardware, software, firmware, some combination thereof, and so forth. In operation, smart video presenter 110 presents videos 104 in accordance with one or more views for video presentation UI 102. Example views include grid view (FIG. 2), list view (FIG. 4), scalable view (FIGS. 5A and 5B), filmstrip view (FIG. 6), tagging view (FIG. 8), categorized views (FIGS. 9A-9D), and so forth.

In an example implementation, smart video presenter 110 is extant on processor-accessible media. It may be a stand-alone program or part of another program. Smart video presenter 110 may be located at a single device or distributed over two or more devices (e.g., in a client-server architecture). Example applications include, but are not limited to: (1) search result presentation for a video search engine, including from both the server/web hosting side and/or the client/web browsing side; (2) video presentation for online video services, such as video hosting, video sharing, video chatting, etc.; (3) video presentation for desktop applications such as an operating system, a media program, a video editing program, etc.; (4) video presentation for internet protocol television (IPTV); and (5) video presentation for mobile devices.

In a described implementation, videos are categorized and separated into segments. The videos can then be presented with reference to their assigned categories and/or based on their segmentations. However, neither the categorization nor the segmentation need be performed for every implementation of smart video presentation.

In an example implementation, smart video presentation may include the following procedures: (1) video categorization, (2) video segmentation, (3) video thumbnail selection, and (4) video summarization. Examples of these procedures are described briefly below in this section, and example video presentation UIs are described in detail in the following section with reference to FIGS. 2-9D.

Videos are divided into a set of predefined categories. Example categories include, but are not limited to, news, sports, home videos, landscape, movies, and so forth. Each category may also have subcategories, such as action, comedy, romance, etc. for a movie category. After classifying videos into different categories, each video is segmented into a multilayer temporal structure, from small segments to large segments. This multiplayer temporal structure may be composed of shots, scenes, and chapters, from smaller to larger segments.

By way of example only, a shot is considered to be a continuous strip of video that is created from a series of frames and that runs for an uninterrupted period of time. A scene is considered to be a series of (consecutive) similar shots concerning the same or similar event. A chapter is considered to be a series of consecutive scenes defined according to different video categories (e.g., this may be enacted similar to the “chapter” construct in DVD discs). For news videos for instance, each chapter may be a piece of news (i.e., a news item); for home videos, each chapter may be a series of scenes taken in the same park.

Videos in different categories may have different video segmentation methods or parameters to ensure segmentation accuracy. Furthermore, certain video categories may have more than the three layers mentioned above. For example, a long shot may have several sub-shots (e.g., smaller segments that each have a unique camera motion within a shot), and some videos may have larger segment units than chapters. For the sake of clarity but by way of example only, the descriptions below use a three-layer segmentation structure to set forth example implementations for smart video presentation.

Furthermore, both overall videos and their constituent segments (whether such segments be chapters, scenes, shots, etc.) are termed video objects. A video object may be the basic unit for video searching. Consequently, all of the videos on the internet, on a desktop computer, and/or on a mobile device can be arranged hierarchically—from biggest to smallest, by all videos; by video categories; by chapter, scene, and shot; and so forth.

In a described implementation, static thumbnail extraction may be performed by selecting a good, and hopefully even the best, frame to represent a video segment. By way of example only, a good frame may be considered to satisfy the following criteria: (1) good visual quality (e.g., non-black, high contrast, not blurred, good color distribution, etc.); (2) non-commercial (e.g., which is a particularly applicable criterion when choosing thumbnails for recorded TV shows); and (3) representative of the segment to which it is to correspond.

Two example video summarization approaches or types are described herein: static video summarization and dynamic video summarization. Static video summarization uses a set of still images (static frames extracted from a video) to represent the video. Dynamic video summarization, on the other hand, uses a set of short clips to represent the video. Generally, the “information fidelity” of the video summary is increased by choosing an appropriate set of frames (for a static summary) or clips (for a dynamic summary). Other approaches to video summarization may alternatively be implemented.

As used in the description herein, a zone of a UI is a user-recognizable screen portion of a workspace. Examples of zones include, but are not limited to, windows (including pop-up windows), window panes, tabs, some combination thereof, and so forth. Often, but not always, a user is empowered to change the size of a given zone. A region of a zone contains one or more identifiable UI components. One UI component may be considered to be proximate to another UI component if a typical user would expect there to likely be a relationship between the two UI components based on their positioning or placement within a region of a UI zone.

### Example Implementations for Smart Video Presentation

FIG. 2 is a block diagram illustrating an example grid view 200 for smart video presentation. As illustrated, grid view 200 includes a video presentation UI 102. By way of example only, video presentation UI 102 is depicted as a window having a scroll feature 210. Video presentation UI 102 may alternatively be realized as any type of UI zone generally. Grid view 200 also includes multiple static thumbnails 202 and related UI components 204, 206, and 208. However, different and/or additional UI components may also be included. Six static thumbnails 202(1, 2, 3, 4, 5, 6) and their associated UI components are visible, but more or fewer UI component sets may be included for grid view 200.

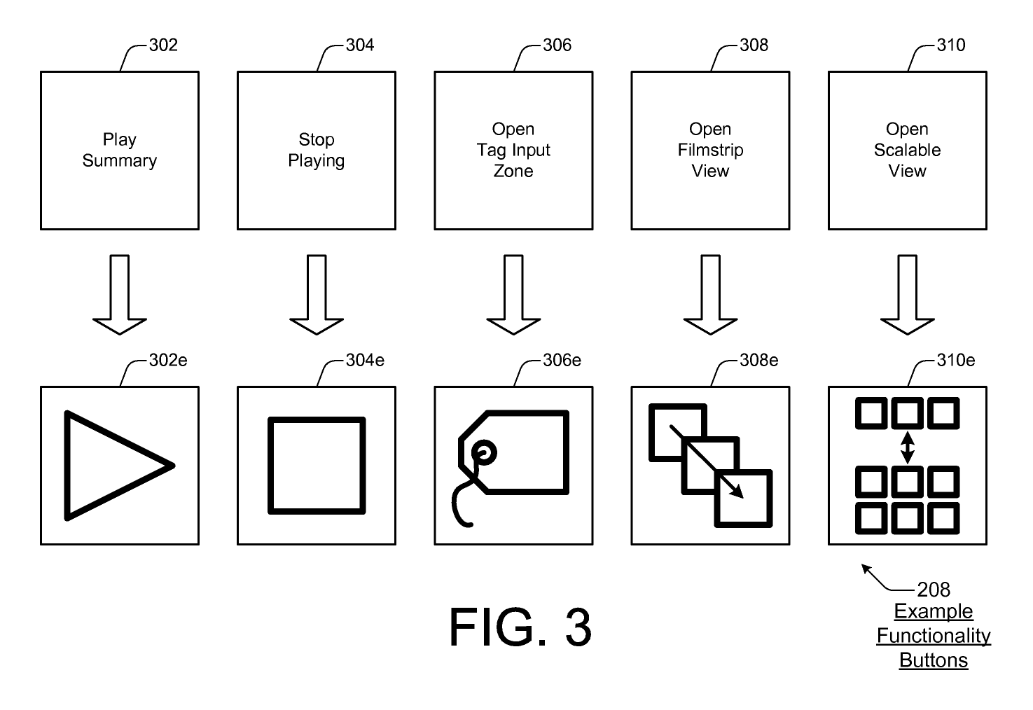

Each respective static thumbnail 202 and its three respective associated UI components 204, 206, and 208 are organized into a grid. The three example illustrated UI components for each static thumbnail 202 are: a length indicator 204, descriptive text 206, and functionality buttons 208. Length indicator 204 provides the overall length of the corresponding video 104. Example functionality buttons 208 are described herein below with particular reference to FIG. 3.

Descriptive text 206 includes text that provides some information on the corresponding video 104. By way of example only, descriptive text 206 may include one or more of the following: bibliographic information (e.g., title, author, production date, etc.), source information (e.g., vendor, uniform resource locator (URL), etc.), some combination thereof, and so forth. Furthermore, descriptive text 206 may also include: surrounding text (e.g., if the video is extracted from a web page or other such source file), spoken words from the video, a semantic classification of the video, some combination thereof, and so forth.

FIG. 3 is a block diagram illustrating example functionality buttons 208 for smart video presentation. As illustrated, there are five (5) example functionality buttons 208. However, more or fewer functionality buttons 208 may be included in association with each static thumbnail (such as static thumbnail 202 of FIG. 2). The five example functionality buttons are shown conceptually at 302-310 in the top half of FIG. 3. The bottom half of FIG. 3 depicts example visual representations 302e-310e for a graphical UI.

The five example functionality buttons are: play summary 302, stop playing (summary) 304, open tag input area 306, open filmstrip view 308, open scalable view 310. Functionality buttons 302-310 may be activated with a point-and-click device (e.g., a mouse), with keyboard commands (e.g., multiple tabs and the enter key), with verbal input (e.g., using voice recognition software), some combination thereof, and so forth.

Play summary button 302, when activated, causes video presentation UI 102 to play a dynamic summary of the corresponding video 104. This summary may be, for example, a series of one or more short clips showing different parts of the overall video 104. These clips may also reflect a segmentation level at the shot, scene, chapter, or other level. These clips may be as short as one frame, or they may extend for seconds, minutes, or even longer. A clip may be presented for each segment of video 104 or only for selected segments (e.g., for those segments that are longer, more important, and/or have high “information fidelity”, etc.).

A dynamic summary of a video may be ascertained using any algorithm in any manner. By way of example only, a dynamic summary of a video may be ascertained using an algorithm that is described in U.S. Nonprovisional patent application Ser. No. 10/286,348 to Xian-Sheng Hua et al., which is entitled “Systems and Methods for Automatically Editing a Video”. In an algorithm thereof, an importance or attention curve is extracted from the video and then an optimization-based approach is applied to select a portion of the video segments to “maximize” the overall importance and distribution uniformity, which may be constrained by the desired duration of the summary.

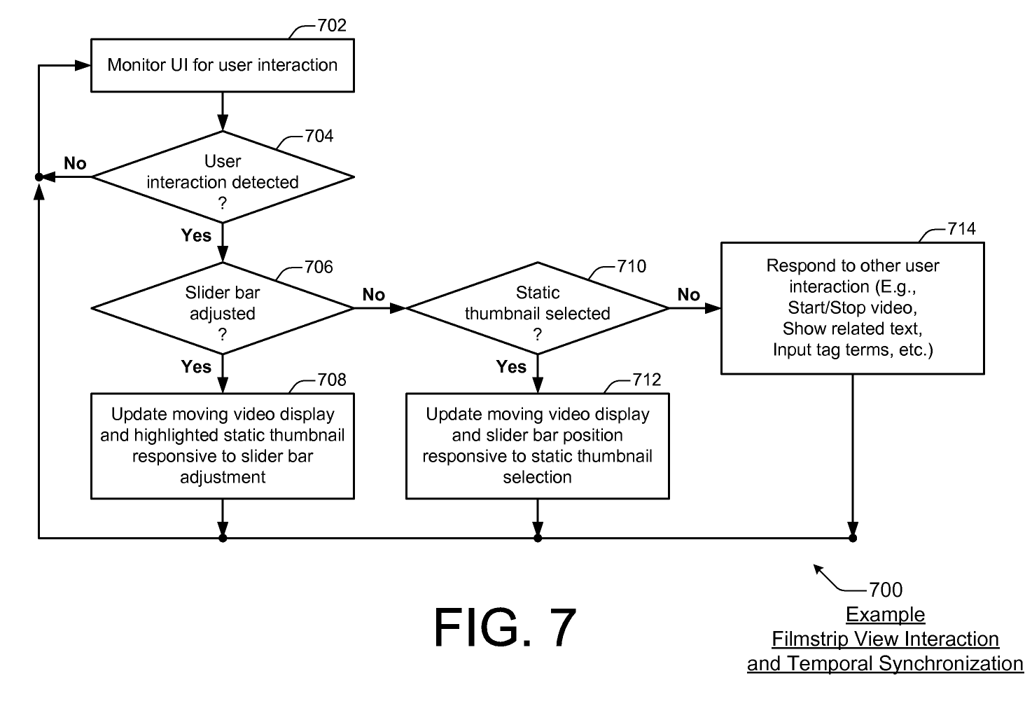

Stop playing button 304 causes the summary or other video playing to stop. Open tag input zone button 306 causes a zone to be opened that enables a user to input tagging information to be associated with the corresponding video 104. An example tag input zone is described herein below with particular reference to FIG. 8. Open filmstrip view button 308 causes a zone to be opened that presents videos in a filmstrip view. An example filmstrip view and user interaction therewith is described herein below with particular reference to FIGS. 6 and 7. Open scalable view button 310 causes a zone to be opened that presents videos in a scalable view. An example scalable view is described herein below with particular reference to FIGS. 5A and 5B.

UI functionality buttons 302e-310e depict graphical icons that are examples only. Play summary button 302e has a triangle. Stop playing button 304e has a square. Open tag input zone button 306e has a string-tied tag. Open filmstrip view button 308 has three squares linked by an arrow. Open scalable view button 310 has sets of three squares and six squares connected by a double arrow.

FIG. 4 is a block diagram illustrating an example list view 400 for smart video presentation. As illustrated, list view 400 includes a list of multiple respective video entries 410(1,2, . . . ) corresponding to multiple respective videos 104(1,2, . . . ) (of FIG. 1). Each video entry 410 includes three regions: [1] a larger static thumbnail region (on the left side of the entry), [2] a descriptive text region (on the upper right side of the entry), and [3] a smaller static thumbnail region (on the lower right side of the entry). Example UI components for each of these three regions is described below.

In a described implementation, the larger static thumbnail region includes a larger static thumbnail 402, length indicator 204, and functionality buttons 208. Larger static thumbnail 402 can be an image representing an early portion, a high information fidelity portion, and/or a more important portion of the corresponding video 104. Length indicator 204 and functionality buttons 208 may be similar or equivalent to those UI components described above with reference to FIGS. 2 and 3.

The descriptive text region includes descriptive text 406. Descriptive text 406 may be similar or equivalent to descriptive text 206 described above with reference to FIG. 2.

The smaller static thumbnail region includes one or more smaller static thumbnails 404, time indexes (TIs) 408, and functionality buttons 208*. As illustrated, the smaller static thumbnail region includes four sets of UI components 404, 408, and 208*, but any number of sets may alternatively be presented. Each respective smaller static thumbnail 404(1,2,3,4) is an image that represents a different time, as indicated by respective time index 408(1,2,3,4), during the corresponding video 104.

The image of each smaller static thumbnail 404 may correspond to one or more segments of the corresponding video 104. These segments may be at the same or different levels. Time indexes 408 reflect the time of the corresponding segment. For example, a time index 408 may be the time at which the playable clip summary starts and/or the time at which the corresponding segment starts. Time indexes 408 may, for example, be based on segments or may be determined by dividing a total length of the corresponding video 104 by the number of smaller static thumbnails 404 to be displayed.

Static thumbnails 404 and/or time indexes 408 for a list view 400 may be ascertained using any algorithm in any manner. By way of example only, static thumbnails 404 and/or time indexes 408 for a list view 400 may be ascertained using an algorithm presented in “A user attention model for video summarization” (Yu-Fei Ma, Lie Lu, Hong-Jiang Zhang, and Mingjing Li; Proceedings of the tenth ACM international conference on Multimedia; Dec. 01-06, 2002; Juan-les-Pins, France). Example algorithms therein are also based on extracting an importance/attention curve.

Functionality buttons 208* may differ from those illustrated in FIG. 3. For example, functionality buttons 308 and 310 may be omitted, especially when they are included as part of functionality buttons 208 in the larger static thumbnail region. Additionally, the video clip played when play summary button 302 (of functionality buttons 208*) is activated may relate specifically to the displayed frame of smaller static thumbnail 404. The tagging enabled by open tag input zone button 306 may also tag the segment corresponding to the displayed image of smaller static thumbnail 404 instead of or in addition to tagging the entire video 104.

FIG. 5A is a block diagram illustrating a first example scalable view 500A for smart video presentation. As illustrated, scalable view 500A includes two regions: [1] a scaling interface region and [2] a static thumbnail region. The scaling interface region includes a scaling interface tool 502. The static thumbnail region includes a scalable number of sets of UI components 504, 506, and 208*. A selectable scaling factor determines the number of static thumbnails 504 that are displayed at any given time.

In a described implementation, the scaling interface region includes at least one scaling interface tool 502. As shown, a user may adjust the scaling factor using a scaling slider 502(S) and/or scaling buttons 502(B). As the slider of scaling slider 502(S) is moved, the scaling factor is changed. By way of example only, scaling buttons 502(B) are implemented as radio-style buttons that enable one scaling factor to be selected at any given time.

Although four scaling factors (1×, 2×, 3×, and 4×) are specifically shown for scaling buttons 502(B) in FIG. 5A, any number of scaling factors may be implemented. Also, scaling slider 502(S) may have a different number of scaling factors (e.g., may have a different granularity) than scaling buttons 502(B).

For the static thumbnail region, five sets of UI components 504, 506, and 208* are illustrated. For the illustrated example scalable view 500A, the “1×” scaling factor is activated. In other implementations and/or for other videos 104 (of FIG. 1), a “1×” scaling factor may result in fewer or more than five sets of UI components. As the scaling factor is increased by scaling interface tool 502, the number of sets of UI components likewise increases. This is described further below with particular reference to FIG. 5B.

Each of the five sets of UI components includes: a static thumbnail 504, a time index (TI) 506, and functionality buttons 208*. As illustrated, five respective static thumbnails 504(S,1,2,3,E) are associated with and presented proximate to five respective time indexes 506(S,1,2,3,E). The displayed frame of a static thumbnail 504 reflects the associated time index 506.

For example scaling view 500A, time indexes 506 span from a starting time index 506(S), through three intermediate time indexes 506(1,2,3), and finally to an ending time index 506(E). These five time indexes may correspond to particular segments of the corresponding video 104, may equally divide the corresponding video 104, or may be determined in some other fashion. The particular segments may, for example, correspond to portions of the video that have good visual quality, high information fidelity, and so forth.

Static thumbnails 504 and/or time indexes 506 for a scalable view 500 may be ascertained using any algorithm in any manner. By way of example only, static thumbnails 504 and/or time indexes 506 for a scalable view 500 may be ascertained using an algorithm presented in “Automatic Music Video Generation Based on Temporal Pattern Analysis” (Xian-Sheng Hua, Lie Lu, and Hong-Jiang Zhang; ACM Multimedia; Oct. 10-16, 2004; New York, N.Y., USA). The numbers of thumbnails of the scalable view may be applied as the constraints for selecting an optimal set of thumbnails.

Functionality buttons 208* may differ from those illustrated in FIG. 3. For example, functionality buttons 308 and 310 may be omitted, especially when they are otherwise included once as part of video presentation UI 102 (which is not explicitly shown in FIG. 5A). As an example alternative, open scalable view button 310 may become an open/return to list view button. Additionally, the video clip played when play summary button 302 is activated may relate specifically to the displayed frame of static thumbnail 504. The tagging enabled by open tag input zone button 306 may also tag the segment corresponding to the displayed frame of static thumbnail 504 instead of or in addition to tagging the entire video 104.

FIG. 5B is a block diagram illustrating a second example scalable view 500B for smart video presentation. With scalable view 500B, the “3×” scaling factor has been activated via scaling interface tool 502. In this example, activation of the “3×” scaling factor results in 15 time indexes and 15 associated static thumbnails 504. However, in other implementations and/or for other videos 104 (of FIG. 1), a “3×” scaling factor may result in fewer or more than 15 sets of UI components.

These 15 sets of UI components start with time index 506(S) and associated static thumbnail 504(S). Thirteen intermediate time indexes 1 . . . 13 and their associated static thumbnails 504(1 . . . 13) are also presented. The “3×” scaling factor scalable view display ends with time index 506(E) and associated static thumbnail 504(E). For this example, activation of the “2×” scaling factor may produce 10 sets of UI components, and activation of the “4×” scaling factor may produce 20 sets of UI components.

FIG. 6 is a block diagram illustrating an example filmstrip view 600 for smart video presentation. As illustrated, filmstrip view 600 includes five regions. These five regions include: [1] a video player region, [2] a video slider bar region, [3] a video data region, [4] a filmstrip or static thumbnail region, and [5] a scaling interface tool region. Each of these five regions, as well as their interrelationships, is described below.

The video player region includes a video player 602 that may be utilized by a user to play video 104. One or more video player buttons may be included in the video player region. A play button (with triangle) and a stop button (with square) are shown. Other example video player buttons (not shown) that may be included are fast forward, fast backward, skip forward, skip backward, pause, and so forth.

The video slider bar region includes a slider bar 604 and a slider 606. As video 104 is played by video player 602 of the video player region, slider 606 moves (e.g., in a rightward direction) along slider bar 604 of the slider bar region. If, for example, fast backward is engaged at video player 602, slider 606 moves faster (e.g., in a leftward direction) along slider bar 604. Conversely, if a user manually moves slider 606 along slider bar 604, the segment of video 104 that is being presented changes responsively. If, for example, a user moves slider 606 a short distance along slider bar 604, the segment being presented jumps temporally a short distance. If, for example, a user moves slider 606 a longer distance along slider bar 604, the segment being presented jumps temporally a longer distance. The user can move the position of slider 606 in either direction along slider bar 604 to skip forward or backward a desired temporal distance.

The video data region includes multiple tabs 608. Although two tabs 608 are illustrated, any number of tabs 608 may alternatively be implemented. Video information tab 608V may include any of the information described above for descriptive text 206 with reference to FIG. 2. When a user selects tags tab 608T, any tags that have been associated with the corresponding video 104 may be displayed. The presented tags may be set to be public tags, private tags of the user, both public and private tags, and so forth. Additionally, tags tab 608T may enable the user to add tags that are to be associated with video 104. These tags may be set to be only those tags associated with the entire video 104, those tags associated with the currently playing video segment, both kinds of tags, and so forth. An example tag entry interface is described herein below with particular reference to FIG. 8.

A filmstrip or static thumbnail region includes multiple sets of UI components. As illustrated, there are five sets of UI components, each of which includes a static thumbnail 614, an associated and proximate time index (TI) 610, and associated and proximate functionality buttons 612. However, each set may alternatively include more, fewer, or different UI components. In the example filmstrip view 600, static thumbnails 614 are similar to static thumbnails 504 (of FIGS. 5A and 5B) in that their number is adjustable via a scaling interface tool 502. Alternatively, their number can be established by an executing application, by constraints of video 104, and so forth, as is shown by example list view 400 (of FIG. 4).

In operation, filmstrip view 600 of video presentation UI 102 implements a filmstrip-like feature. As video 104 is played by video player 602, a static thumbnail 614 reflecting the currently-played segment is shown in the static thumbnail region. Moreover, the current static thumbnail 614 may be highlighted, as is shown with static thumbnail 614(1). In this implementation, a different static thumbnail 614 becomes highlighted as the video 104 is played.

There is therefore an interrelationship established between and among (i) the group of static thumbnails 614, (ii) the slider bar 604/slider 606, and (iii) the video frame currently being displayed by video player 602. More specifically, these three features are maintained in a temporal synchronization.

As video 104 plays on video player 602, slider 606 moves along slider bar 604 and the highlighted static thumbnail 614 changes. The user can control the playing at video player 602 with the video player buttons, as described above, with a pop-up menu option, or another UI component.

When the user manually moves slider 606 along slider bar 604, the displayed frame on video player 602 changes and a new segment may begin playing. The currently-highlighted static thumbnail 614 also changes in response to the manual movement of slider 606. Furthermore, slider 606 and the image on video player 602 can be changed by a user when a user manually selects a different static thumbnail 614 to be highlighted. The manual selection can be performed with a point-and-click device, with keyboard input, some combination thereof, and so forth.

Manually selecting a different static thumbnail 614 causes slider 606 to move to a corresponding position along slider bar 604 and causes a new frame to be displayed and a new segment to be played at video player 602. For example, a user may select static thumbnail 614(3) at time index TI-3. In response, a smart video presenter 110 (of FIG. 1) highlights static thumbnail 614(3) (not explicitly indicated in FIG. 6), moves slider 606 to a position along slider bar 604 that corresponds to time index TI-3, and begins playing video 104 at a time corresponding to time index TI-3.

A scaling interface tool region, when presented, includes at least one scaling interface tool 502. The scaling interface tool may also be considered part of the filmstrip region to which it pertain. As illustrated, scaling buttons 502(B) (of FIGS. 5A and 5B) are placed within the window pane for the static thumbnail region. The “2×” scaling factor is shown as being activated. Up/down and left/right scrolling features 210 enable a user to see all of the static thumbnails for a given activated scaling factor even when video 104 is not being played.

FIG. 7 is a flow diagram 700 that illustrates an example of a method for handling user interaction with a filmstrip view of a smart video presentation implementation. Flow diagram 700 includes seven (7) blocks 702-714. Although the actions of flow diagram 700 may be performed in other UI environments and with a variety of hardware, firmware, and software combinations, certain aspects of FIGS. 1 and 6 are used to illustrate an example of the method of flow diagram 700. For instance, the actions of flow diagram 700 may be performed by a smart video presenter 110 in conjunction with an example filmstrip view 600.

In a described implementation, starting at block 702, a UI is monitored for user interaction. For example, a video presentation UI 102 including a filmstrip view 600 may be monitored to detect an interaction from a user. If no user interaction is detected at block 704, then monitoring continues (at block 702). If, on the other hand, user interaction is detected at block 704, then the method continues at block 706.

At block 706, it is determined if the slider bar has been adjusted. For example, it may be detected that the user has manually moved slider 606 along slider bar 604. If so, then at block 708 the moving video display and the highlighted static thumbnail are updated responsive to the slider bar adjustment. For example, the display of video 104 on video player 602 may be updated, and which static thumbnail 614 is highlighted may also be updated. If the slider bar has not been adjusted (as determined at block 706), then the method continues at block 710.

At block 710, it is determined if a static thumbnail has been selected. For example, it may be detected that the user has manually selected a different static thumbnail 614. If so, then at block 712 the moving video display and the slider bar position are updated responsive to the static thumbnail selection. For example, the display of video 104 on video player 602 may be updated, and the position of slider 606 along slider bar 604 may also be updated. If no static thumbnail has been selected (as determined at block 710), then the method continues at block 714.

At block 714, a response is made to a different user interaction. Examples of other user interactions include, but are not limited to, starting/stopping/fast forwarding video, showing related text in a tab, inputting tagging terms, changing a scaling factor, and so forth. If the user interacts with video player 602, then in response the slider bar position and the static thumbnail highlighting may be responsively updated. If the scaling factor is changed, the static thumbnail highlighting may be responsively updated in addition to changing the number of presented static thumbnails 614. After the action(s) of blocks 708, 712, or 714, the monitoring of the UI continues (at block 702).

FIG. 8 is a block diagram illustrating an example tagging view 800 for smart video presentation. Tagging view 800 is shown in FIG. 8 as a pop-up window 802; however, it may be created as any type of zone (e.g., a “permanent” new window, a tab, a window pane, etc.). Tagging view 800 is presented, for example, in response to activation of an open tag input zone button 306. (Tagging tab 608T (of FIG. 6) may also be organized similarly.) Tagging view 800 is an example UI that enables a user to input tagging terms.

Tagging terms are entered at box 804. As described herein above, the entered tagging terms may be associated with an entire video 104, one or more segments thereof, both of these types of video objects, and so forth. The applicability of input tagging terms may be determined by smart video presenter 110 and/or by the context of an activated open tag input zone button 306. For example, an open tag input zone button 306 that is proximate to a particular static thumbnail may be set up to associate tagging terms specifically with a segment that corresponds to the static thumbnail.

The user is also provided an opportunity to specify a video category for a video or segment thereof using a drop-down menu 806. If the video object is fancied by the user, the user can add the video object to his or her selection of favorites with an “Add to My Favorites” button 808. If tags already exist for the video object, they are displayed in an area 810.

FIGS. 9A-9D are abbreviated diagrams illustrating example user interface aspects of video grouping by category for smart video presentation. In a described implementation, videos may be grouped in accordance with one or more grouping criteria. More specifically, in list view and grid view (or otherwise when multiple videos are listed), the video listing can be filtered by different category properties.

FIG. 9A shows a grouping selection procedure and example grouping categories. The video presentation UI includes a category grouping tool that enables a user to filter the multiple video entries by a property selected from a set of properties. During the selection procedure, the grouping indicator line reads “Group by . . . ???? . . . ”. It may alternatively continue to read a current grouping category. The arrow icon is currently located above the “Duration” grouping category.

Example category properties for grouping include: (1) scene, (2) duration, (3) genre, (4) file size, (5) quality, (6) format, (7) frame size, and so forth. Example descriptions of these grouping categories are provided below: (1) Scene—Scene is the place or location of the video (or video segment), such as indoor, outdoor, room, hall, cityscape, landscape, and so forth. (2) Duration—The duration category reflects the length of the videos, which can be divided into three (e.g., long, medium, and short) or more groups.

(3) Genre—Genre indicates the type of the videos, such as news, video, movie, sports, cartoon, music video, and so forth. (4) File Size—The file size category indicates the data size of the video files. (5) Quality—The quality grouping category reflects the visual quality of the video, which can be roughly measured by bit rate, for example. (6) Format—The format of the video, such as WMV, MPEG1, MPEG2, etc., is indicated by this category. (7) Frame Size—The frame size category indicates the frame size of the video, which can be categorized into three (e.g., big, medium, and small) or more groups.

FIG. 9B shows a video listing that is being grouped by “Duration”. Currently, videos of a “Medium” duration are being displayed. FIG. 9C shows a video listing that is being grouped by “Scene”. Currently, videos of a “Landscape” scene setting are being displayed. FIG. 9D shows a video listing that is being grouped by “Format”. As illustrated, the format grouping options include “All—WMV—MPEG—RM—MOV—AVI”. Currently, videos of the “WMV” type are being displayed. Grouping by other video categories, such as genre, file size, quality, frame size, etc., may be implemented similarly.

Some of these grouping categories can be defined manually by the user. For example, the duration category groups of “long”, “medium”, and “short” can be defined manually. Other grouping categories can have properties that are determined automatically by smart video presenter 110 (of FIG. 1), examples of which are described below for scene, genre, and quality. Depending on category properties and grouping criteria, the grouping may be performed for an entire video, for individual segments thereof, and/or for video objects generally.

Sets of video objects may be grouped by scene, genre, quality, etc. using any algorithm in any manner. Nevertheless, references to algorithms that are identified by way of example only are included below. A set of video objects may be grouped by scene using an algorithm presented in “Automatic Video Annotation by Semi-supervised Learning with Kernel Density Estimation” (Meng Wang, Xian-Sheng Hua, Yan Song, Xun Yuan, Shipeng Li, and Hong-Jiang Zhang; ACM Multimedia 2006; Santa Barbara, Calif., USA; Oct. 23-27, 2006). A set of video objects may be grouped by genre using an algorithm presented in “Automatic Video Genre Categorization Using Hierarchical SVM” (Xun Yuan, Wei Lai, Tao Mei, Xian-Sheng Hua, and Xiu-Qing Wu; The International Conference on Image Processing (ICIP 2006); Atlanta, Ga., USA; Oct. 8-11, 2006). A set of video objects may be grouped by quality using an algorithm presented in “Spatio-Temporal Quality Assessment for Home Videos” (Tao Mei, Cai-Zhi Zhu, He-Qin Zhou, and Xian-Sheng Hua; ACM Multimedia 2005; Singapore; Nov. 6-11, 2005).

### Example Device Implementations for Smart Video Presentation

FIG. 10 is a block diagram of an example device 1002 that may be used to implement smart video presentation. Multiple devices 1002 are capable of communicating over one or more networks 1014. Network(s) 1014 may be, by way of example but not limitation, an internet, an intranet, an Ethernet, a public network, a private network, a cable network, a digital subscriber line (DSL) network, a telephone network, a Fibre network, a Grid computer network, an avenue to connect to such a network, some combination thereof, and so forth.

As illustrated, two devices 1002(1) and 1002(d) are capable of communicating via network 1014. Such communications are particularly applicable when one device, such as device 1002(d), stores or otherwise provides access to videos 104 (of FIG. 1) and the other device, such as device 1002(1), presents them to a user. Although two devices 1002 are specifically shown, one or more than two devices 1002 may be employed for smart video presentation, depending on implementation.

Generally, a device 1002 may represent any computer or processing-capable device, such as a server device; a workstation or other general computer device; a data storage repository apparatus; a personal digital assistant (PDA); a mobile phone; a gaming platform; an entertainment device; some combination thereof; and so forth. As illustrated, device 1002 includes one or more input/output (I/O) interfaces 1004, at least one processor 1006, and one or more media 1008. Media 1008 include processor-executable instructions 1010.

In a described implementation of device 1002, I/O interfaces 1004 may include (i) a network interface for communicating across network 1014, (ii) a display device interface for displaying information (such as video presentation UI 102 (of FIG. 1)) on a display screen 106, (iii) one or more man-machine interfaces, and so forth. Examples of (i) network interfaces include a network card, a modem, one or more ports, a network communications stack, a radio, and so forth. Examples of (ii) display device interfaces include a graphics driver, a graphics card, a hardware or software driver for a screen or monitor, and so forth. Examples of (iii) man-machine interfaces include those that communicate by wire or wirelessly to man-machine interface devices 1012 (e.g., a keyboard, a remote, a mouse or other graphical pointing device, etc.).

Generally, processor 1006 is capable of executing, performing, and/or otherwise effectuating processor-executable instructions, such as processor-executable instructions 1010. Media 1008 is comprised of one or more processor-accessible media. In other words, media 1008 may include processor-executable instructions 1010 that are executable by processor 1006 to effectuate the performance of functions by device 1002.

Thus, realizations for smart video presentation may be described in the general context of processor-executable instructions. Generally, processor-executable instructions include routines, programs, applications, coding, modules, protocols, objects, components, metadata and definitions thereof, data structures, application programming interfaces (APIs), etc. that perform and/or enable particular tasks and/or implement particular abstract data types. Processor-executable instructions may be located in separate storage media, executed by different processors, and/or propagated over or extant on various transmission media.

Processor(s) 1006 may be implemented using any applicable processing-capable technology. Media 1008 may be any available media that is included as part of and/or accessible by device 1002. It includes volatile and non-volatile media, removable and non-removable media, and storage and transmission media (e.g., wireless or wired communication channels). Media 1008 is tangible media when it is embodied as a manufacture and/or composition of matter. For example, media 1008 may include an array of disks or flash memory for longer-term mass storage of processor-executable instructions 1010, random access memory (RAM) for shorter-term storing of instructions that are currently being executed and/or otherwise processed, link(s) on network 1014 for transmitting communications, and so forth.

As specifically illustrated, media 1008 comprises at least processor-executable instructions 1010. Generally, processor-executable instructions 1010, when executed by processor 1006, enable device 1002 to perform the various functions described herein, including providing video presentation UI 102 (of FIG. 1). An example of processor-executable instructions 1010 can be smart video presenter 110. Such described functions include, but are not limited to: (i) presenting grid view 200; (ii) presenting list view 400; (iii) presenting scalable views 500A and 500B; (iv) presenting filmstrip view 600 and performing the actions of flow diagram 700; (v) presenting tagging view 800; (vi) presenting category grouping features; and so forth.

The devices, actions, aspects, features, functions, procedures, modules, data structures, protocols, UI components, etc. of FIGS. 1-10 are illustrated in diagrams that are divided into multiple blocks and components. However, the order, interconnections, interrelationships, layout, etc. in which FIGS. 1-10 are described and/or shown are not intended to be construed as a limitation, and any number of the blocks and components can be modified, combined, rearranged, augmented, omitted, etc. in any manner to implement one or more systems, methods, devices, procedures, media, apparatuses, APIs, arrangements, etc. for smart video presentation.

Although systems, media, devices, methods, procedures, apparatuses, mechanisms, schemes, approaches, processes, arrangements, and other implementations have been described in language specific to structural, logical, algorithmic, and functional features and/or diagrams, it is to be understood that the invention defined in the appended claims is not necessarily limited to the specific components, features, or acts described above. Rather, the specific components, features, and acts described above are disclosed as example forms of implementing the claims.

What is claimed is:

1. A device that is adapted to produce a video presentation user interface (UI) on a display screen, the video presentation UI comprising:
a listing of multiple video entries, each video entry including a larger static thumbnail region and a smaller static thumbnail region for a video corresponding to the video entry;
wherein the larger static thumbnail region includes at least one larger static thumbnail and is capable of playing at least a portion of the corresponding video; and
wherein the smaller static thumbnail region includes multiple smaller static thumbnails that are extracted from the corresponding video at different time indexes.

2. The device as recited in claim 1, wherein each video entry further includes a descriptive text region displaying text that relates to the corresponding video.

3. The device as recited in claim 1, wherein a respective time index associated with each respective smaller static thumbnail is displayed in proximity to each smaller static thumbnail.

4. The device as recited in claim 1, wherein a respective tagging functionality button associated with each respective larger and smaller static thumbnail is displayed in proximity to each static thumbnail, the tagging functionality button enabling a user to tag a video object that corresponds to the static thumbnail with one or more tagging terms.

5. The device as recited in claim 1, wherein the larger static thumbnail region includes multiple functionality buttons in proximity to the larger static thumbnail, the multiple functionality buttons including a play button that plays an abbreviated summary of the corresponding video.

6. The device as recited in claim 1, wherein the video presentation UI further comprises:
a category grouping tool that enables a user to filter the multiple video entries by a property selected from a set of properties comprising: scene, duration, genre, file size, quality, format, and frame size.

7. A device that is adapted to produce a video presentation user interface (UI) on a display screen, the video presentation UI comprising:
a number of static thumbnails for a video, each respective static thumbnail representing a respective time index during the video; and
a scaling interface tool that enables a user to change the number of static thumbnails that are presented for the video;
wherein the number of static thumbnails that are presented for the video is changed when the user adjusts the scaling interface tool.

8. The device as recited in claim 7, wherein the scaling interface tool comprises a scaling slider that adjusts to multiple positions.

9. The device as recited in claim 7, wherein the scaling interface tool comprises multiple radio-style scaling buttons that can be individually selected.

10. The device as recited in claim 7, wherein the respective time index associated with each respective static thumbnail is displayed in proximity to each static thumbnail.

11. The device as recited in claim 10, wherein the number of static thumbnails for the video are presented chronologically responsive to the associated time indexes, a first static thumbnail representing a starting portion of the video and a last static thumbnail representing an ending portion of the video.

12. The device as recited in claim 7, wherein at least one respective functionality button that is associated with each respective static thumbnail of the number of static thumbnails is displayed in proximity to each static thumbnail, the at least one respective functionality button including an open tagging view button that presents, upon activation, a tagging zone that enables a video object associated with the respective static thumbnail to be tagged.

13. One or more processor-accessible tangible media including processor-executable instructions that, when executed, direct a device to produce a video presentation user interface (UI) on a display screen, the video presentation UI comprising:
a video playing region that is capable of playing a video;
a video slider bar region that includes a slider bar and a slider, a graphical position of the slider along the slider bar visually indicating a temporal position of the video being played in the video playing region; and
a filmstrip region that includes multiple static thumbnails extracted from the video at different time indexes.

14. The one or more processor-accessible tangible media as recited in claim 13, wherein the video presentation UI further comprises:
a video data region that includes multiple tabs; the multiple tabs including (i) a video information tab that displays, when selected, information that describes the video and a (ii) a tagging tab that displays, when selected, any tagging information associate with the video;
wherein the tagging tab enables a user to add tagging terms for association with the video.

15. The one or more processor-accessible tangible media as recited in claim 13, wherein the filmstrip region further includes a scaling interface tool that enables a user to change how many of the multiple static thumbnails are currently presented for the video.

16. The one or more processor-accessible tangible media as recited in claim 13, wherein the temporal position of the video displayed in the video playing region, the graphical position of the slider along the slider bar in the video slider bar region, and a highlighted static thumbnail of the filmstrip region are temporally synchronized.

17. The one or more processor-accessible tangible media as recited in claim 16, wherein user interaction at one region selected from the video playing region, the video slider bar region, and the filmstrip region results in the video presentation UI being responsively updated in the other two regions.

18. The one or more processor-accessible tangible media as recited in claim 13, wherein when a user adjusts the graphical position of the slider along the slider bar in the video slider bar region, the video presentation UI is updated in response by synchronizing which static thumbnail in the filmstrip region is currently highlighted and by synchronizing the temporal position of the video displayed in the video playing region.

19. The one or more processor-accessible tangible media as recited in claim 13, wherein when a user selects a different static thumbnail in the filmstrip region to be currently highlighted, the video presentation UI is updated in response by synchronizing the graphical position of the slider along the slider bar in the video slider bar region and by synchronizing the temporal position of the video displayed in the video playing region.

20. The one or more processor-accessible tangible media as recited in claim 19, wherein the video presentation UI is updated by synchronizing the graphical position of the slider and by sychronizing the temporal position of the video to points that correspond to a different time index that is associated with the user-selected different static thumbnail.
